(19) United States
(12) Patent Application Publication
(10) Pub. No.: US 2012/0046773 A1
(43) Pub. Date: Feb. 23, 2012

(54) MOLD DESIGN SYSTEM AND METHOD

(75) Inventors: ZI-ZHUAN GUI, Shenzhen (CN); YUN-XUE HU, Shenzhen (CN); XIAO-MING HU, Shenzhen (CN); TIAN-CHENG HUANG, Shenzhen (CN); PENG YUAN, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/097,059

(22) Filed: Apr. 29, 2011

(30) Foreign Application Priority Data
Aug. 20, 2010 (CN) 201010258999.1

(51) Int. Cl. G05B 19/4097

(52) U.S. Cl. 700/98

(57) ABSTRACT

A mold design system includes an electrode design module, and a central control module. The electrode design module generates a drawing of a mold based on electrode structure parameters. The central control module generates a computerized numerical control (CNC) task, a simulating task, and a testing task according to the drawing generated by the electrode design module.

### BACKGROUND

1. Technical Field

The disclosure generally relates to computerized mold design systems and methods, and particularly to a mold design system and method for controlling operations of different phases of mold design.

2. Description of Related Art

Many mold design processes may include the following phases: designing electrodes, generating computerized numerical control (CNN) manufacture programs, emulating a procedure, and testing the procedure. However, nowadays, the phases described above usually are independently executed and finished by multiple systems, data among which may be inconvenient to share because of compatibility problems. Therefore, some steps may have to be repeated in the different systems, which is inefficient.

Therefore, there is room for improvement within the art.

### BRIEF DESCRIPTION OF THE DRAWINGS

Many aspects of the mold design system and method can be better understood with reference to the following drawings. The components in the drawings are not necessarily drawn to scale, the emphasis instead being placed upon clearly illustrating the principles of the mold design system and method.

FIG. 1 shows a block diagram of a mold design system, according to an exemplary embodiment.

FIG. 2 shows a flowchart of a mold design unit of the mold design system in FIG. 1.

FIG. 3 shows a flowchart of a mold design process of the mold design system in FIG. 1.

### DETAILED DESCRIPTION

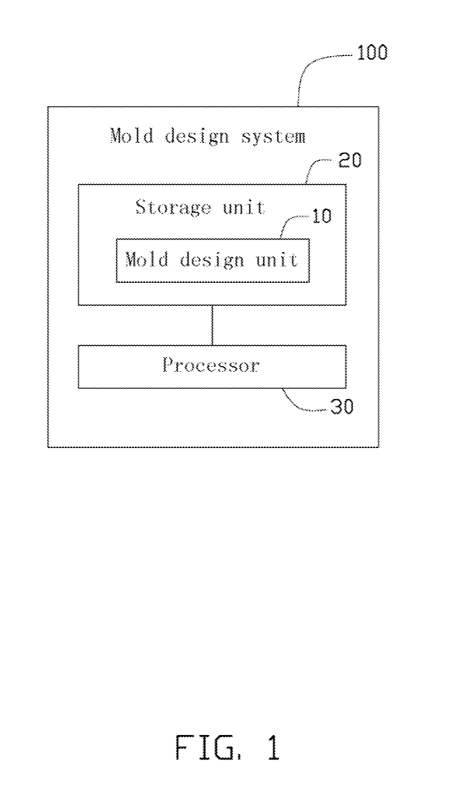

FIG. 1 shows a block diagram of a mold design system 100, according to an exemplary embodiment. The mold design system 100 includes a mold design unit 10, a storage unit 20 and a processor 30. The mold design unit 10 comprises one or more software programs stored in the storage unit 20 and can be executed by the processor 30 to design a mold.

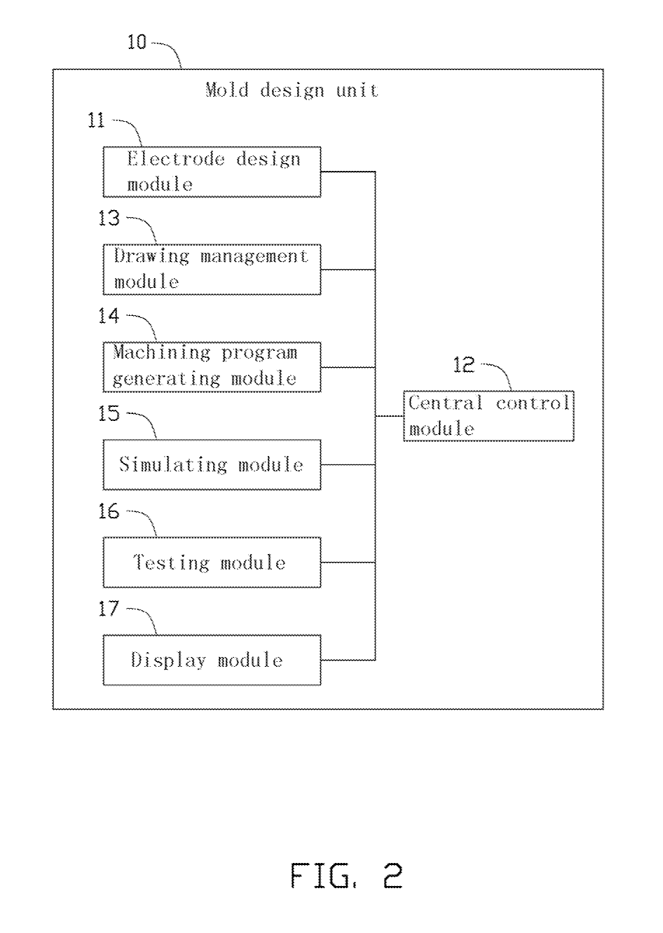

Referring to FIG. 2, the mold design unit 10 includes an electrode design module 11, a central control module 12, a drawing management module 13, a machining program generating module 14, a simulating module 15, a testing module 16, and a display module 17. The electrode is a discharge portion of the mold. The electrode design module 11, the drawing management module 13, the machining program generating module 14, the simulating module 15, the testing module 16, and the display module 17 are connected to the central control module 12. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The electrode design module 11 generates a drawing of the designed mold based on electrode structure parameters. The electrode design module 11 is also used to design an electrode for discharge portions of the mold to be designed, and in the drawing color codes the electrode to distinguish the discharge m other portions. Then, the electrode module 11 outputs the drawing of the mold to be designed portion fro and uploads the drawing to the central control module 12. The electrode structure parameters such as shape and dimensions can be defined or preset by users.

The central control module 20 stores the drawing and generates a computerized numerical control (CNC) task, a simulating task and a testing task according to the drawing. The CNC task is to generate a machine program for the mode. In this exemplary embodiment, the machine program may include generating machining paths, modifying the machining paths, optimizing machining paths, and outputting machining program code for users.

The simulating task is to simulate the machine process for the mold. In this exemplary embodiment, the simulating task may include setting simulating parameters, such as simulating time, simulating the machining paths and outputting simulating results.

The testing task is to generate testing routes for the mold and to execute collision tests of the testing routes. In this exemplary embodiment, the testing task may includes importing a plurality of sampling points, generating testing routs based on the sampling points, executing collision tests according to the testing routs and outputting testing results.

The drawing management module 13 obtains the drawing from the central control module 12. The drawing management module 13 analyzes structure parameters of the electrode, thereby sampling data of points of the electrode which need to be machined. In addition, the drawing management module 13 can output the drawing in different formats such as a 2D drawing or a 3D drawing.

The program generating module 14 obtains the CNC task from the central control module 12, obtains the structure parameters and color character of the electrode from the electrode design module 11, and obtains the data of sampled points of the electrode from the drawing management module 13. Moreover, machining means and cutting tool types, which can be used to machine the mold, are pre-stored in the program generating module 14. The program generating module 14 generates a machine program for the mold based on the data described above.

The simulating module 15 obtains the simulating task from the central control module 12 and simulates a machine process for the mold. In addition, the simulating module 15 stores the simulating result, and uploads the simulating result to the central control module 12.

The testing module 16 obtains the testing task from the central control module 12, and imports the sampling data of points of the electrode from the drawing management module 13. The testing module 16 generates testing routes based on the sampling data, and executes collision tests of the testing routes. The testing module 16 also can output testing program codes for users.

The display module 17 displays working processes of the electrode design module 11, the drawing management module 31, the machining program generating module 41, the simulating module 51, and the testing module 61, and also can be used to check executing state of the CNC task, the simulating task and the testing task. If the CNC task, the simulating task or the testing task is abnormally executed, it can be returned to the central control module 21 and executed again by the corresponding module. If the CNC task, the simulating task and the testing task are abnormally executed, the mold can be machined.

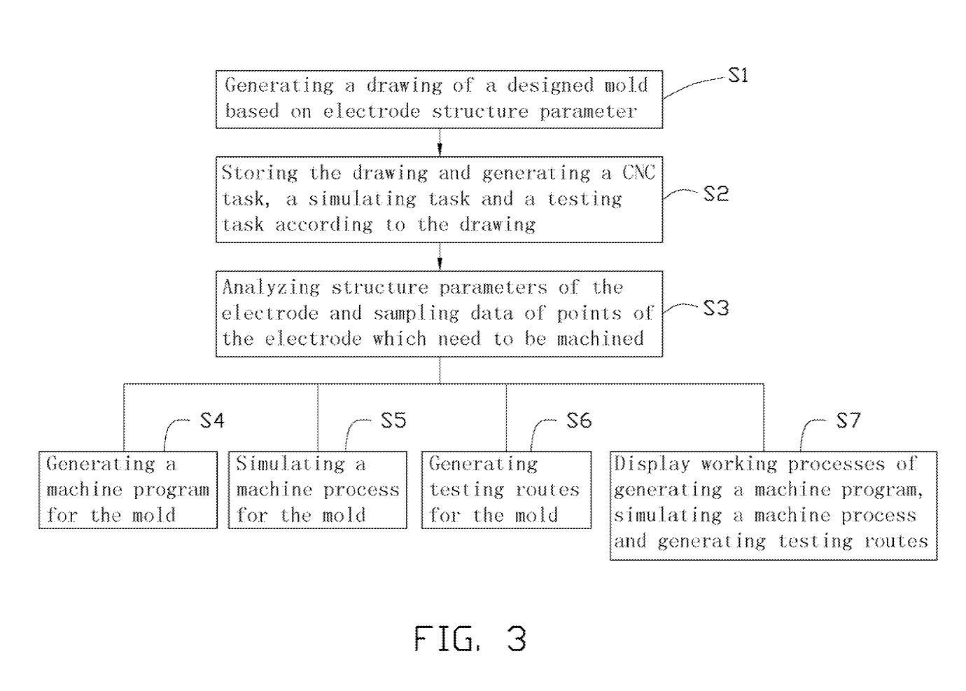

Referring to FIG. 3, a mold design process of the mole design system 100 may include following steps:

In step S1, the electrode design module 11 generates a drawing of a designed mold based on electrode structure parameters. The electrode design module 11 also designs an electrode for discharge portions of the mold to be designed, and in the drawing color codes the electrode to distinguish the discharge portion from other portions. After that the process goes to step S2.

In step S2, the central control module 20 stores the drawing and generates a CNC task, a simulating task and a testing task according to the drawing and the process goes to step S3.

In step S3, the drawing management module 13 analyzes structure parameters of the electrode, thereby sampling data of points of the electrode which need to be machined. The process goes to steps S4, S5, S6 or S7. In addition, steps S4, S5, S6 and S7 may be simultaneously executed after step S3.

In step S4, the program generating module 14 obtains the CNC task from the central control module 12, obtains the structure parameters and color character of the electrode from the electrode design module 11, and obtains the data of sampled points of the electrode from the drawing management module 13. The program generating module 14 generates a machine program for the mold based on the data described above.

In step S5, the simulating module 15 obtains the simulating task from the central control module 12 and simulates the machine process for the mold.

In step S6, the testing module 16 obtains the testing task from the central control module 12, and imports the sampling data of points of the electrode from the drawing management module 13. The testing module 16 generates testing routes based on the sampling data, and executes collision tests of the testing routes.

In step S7, the display module 17 displays working processes of the electrode design module 11, the drawing management module 31, the machining program generating module 41, the simulating module 51, and the testing module 61.

The mold design system 100 assigns the CNC task, the simulating task and the testing task respectively to the machining program generating module 14, the simulating module 15, and the testing module 16. Therefore, relative design data can be shared in the mold design system 100, and the design efficiency can be improved.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A mold design system, comprising:
a storage unit;
a processor; and
one or more programs stored in the storage unit and executed by the processor, the one or more programs comprising:
an electrode design module for generating a drawing of a mold based on electrode structure parameters;
a central control module for generating a computerized numerical control (CNC) task to generate a machine program for the mode, a simulating task to simulate a machine process for the mold, and a testing task to generate testing routes for the mold and to execute a collision test of the testing routes according to the drawing.

2. The mold design system as claimed in claim 1, wherein the one or more programs further comprise a machining program generating module for obtaining the CNC task to generate the machine program for the mold.

3. The mold design system as claimed in claim 1, wherein the one or more programs further comprise a simulating module for obtaining the simulating task to simulate the machine process for the mold.

4. The mold design system as claimed in claim 1, wherein the one or more programs further comprise a testing module for obtaining the testing task to generate the testing routes for the mold and execute the collision test of the testing routes.

6. The mold design system as claimed in claim 1, wherein the electrode design module designs an electrode for a discharge portion of the mold, and colors the electrode to distinguish the discharge portion in the drawing from other portions of the drawing.

7. The mold design system as claimed in claim 1, wherein the one or more programs further comprise a drawing management module, wherein the drawing management obtains the drawing from the central control module and analyzes structure parameters of the electrode, thereby sampling data of portions of the electrode which need to be machined.

8. The mold design system as claimed in claim 7, wherein the machine program generated by the program generating module is based on the CNC task, structure parameters and color character of the electrode, the data of sampled points of the electrode, and machining means and cutting tool types.

9. The mold design system as claimed in claim 8, wherein the machine program includes generating machining paths, modifying the machining paths, optimizing machining paths, and outputting machining program code.

10. The mold design system as claimed in claim 7, wherein the testing module imports the sampling data of points of the electrode from the drawing management module, and generates the testing routes based on the sampling data, and then executes collision tests of the testing routes.

11. The mold design system as claimed in claim 10, wherein the testing module outputs testing program codes.

12. The mold design system as claimed in claim 7, further including a display module, wherein the display module displays working processes of the electrode design module, the drawing management module, the machining program generating module, the simulating module, and the testing module.

13. A mold design method, comprising:
generating a drawing of a designed mold based on electrode structure parameter;
storing the drawing and generating a computerized numerical control (CNC) task, a simulating task and a testing task according to the drawing;
obtaining the CNC task to generate a machine program for the mold;
obtaining the simulating task to simulate the machine process; and
obtaining the test task to generate testing routes for the mold and executing collision tests of the testing routes.

14. The mold design method as claimed in claim 13, further comprising designing an electrode for a discharge portion of the mold and coloring the electrode to distinguish the discharge portion from other portions of the drawing after generating the drawing.

15. The mold design method as claimed in claim 14, further comprising analyzing structure parameters of the electrode, and sampling data of portions of the electrode which need to be machined after generating the drawing of the designed mold.

16. The mold design method as claimed in claim 13, further comprising displaying working processes of generating a machine program, simulating a machine process, and generating testing routes.
